(19) United States
(12) Patent Application Publication
(10) Pub. No.: US 2016/0119186 A1
(43) Pub. Date: Apr. 28, 2016

(54) ZERO-CONFIGURATION NETWORKING PROTOCOL

(71) Applicant: Hangzhou H3C Technologies Co., Ltd., Hangzhou City (CN)

(72) Inventors: Guoxiang XU, Beijing (CN); Haitao ZHANG, Beijing (CN)

(73) Assignee: Hangzhou H3C Technologies Co., Ltd., Hangzhou City (CN)

(21) Appl. No.: 14/895,191

(22) PCT Filed: Mar. 24, 2014
(86) PCT No.: PCT/CN2014/073915

§ 371 Date: Dec. 1, 2015

(30) Foreign Application Priority Data
Jun. 9, 2013 (CN) 201310230618.2

(51) Int. Cl. H04L 12/24; H04L 29/08; H04L 12/26; H04L 29/12

(52) U.S. Cl. CPC H04L 41/0806; H04L 61/1511; H04L 67/1095; H04L 43/08; H04L 61/2061; H04L 61/2069

(57) ABSTRACT

According to an example, a network device serving as a monitoring device for a zero-configuration network protocol is in a subnet in a network including multiple subnets. The monitoring device may receive and update a service in another subnet that is notified by a manager. Also, the monitoring device may respond to a query for the service from a terminal in the subnet when the queried service is in another subnet.

### BACKGROUND

A zero-configuration network protocol includes processes to create a computer network with little or no human involvement. For example, a network administrator may manually configure Dynamic Host Configuration Protocol (DHCP) and Domain Name System (DNS) services and computer network settings. A zero-configuration network protocol may automate these procedures. BONJOUR is an example of an open zero-configuration network standard that is based on a multicast domain name system (mDNS). In a network, a device employing BONJOUR may automatically propagate service information of the device itself and detect service information of other devices. As such, systems and services within a local area network (LAN) may easily be found through BONJOUR even if there is no network administrator. BONJOUR may display names of devices and applications that are in the LAN and support a multicast domain protocol. BONJOUR may employ the mDNS to solve naming conflict between devices in the LAN.

### BRIEF DESCRIPTION OF THE DRAWINGS

Features of the present disclosure are illustrated by way of example and not limited in the following figure(s), in which like numerals indicate like elements, in which:

FIG. 1 is a flowchart illustrating a method for implementing a BONJOUR service, according to an example of the present disclosure.

FIG. 2 is a flowchart illustrating a method for implementing a BONJOUR service, according to an example of the present disclosure.

FIG. 3a is a schematic diagram illustrating a structure of a network device, according to an example of the present disclosure.

FIG. 3b is a schematic diagram illustrating a hardware structure of a network device, according to an example of the present disclosure.

FIG. 4a is a schematic diagram illustrating a structure of a BONJOUR manager, according to an example of the present disclosure.

FIG. 4b is a schematic diagram illustrating a structure of a BONJOUR manager, according to an example of the present disclosure.

FIG. 4c is a schematic diagram illustrating a hardware structure of a BONJOUR manager, according to an example of the present disclosure.

FIG. 4d is a schematic diagram illustrating a hardware structure of a BONJOUR manager, according to an example of the present disclosure.

### DETAILED DESCRIPTION

Hereinafter, the present disclosure will be described in further detail with reference to the accompanying drawings and examples to make the technical solution and merits therein clearer.

In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, and the term “including” means including but not limited to. The term “based on” means based at least in part on. In addition, the terms “a” and “an” are intended to denote at least one of a particular element.

The systems, devices, methods and operations of the present disclosure are described by way of example and not limitation to the BONJOUR zero-configuration network protocol. However, the systems, devices, methods and operations of the present disclosure may be implemented in other types of zero-configuration network protocols. A zero-configuration network protocol includes automated processes implementable by network devices to create a computer network instead of being performed by a human. Bonjour is APPLE's zero-configuration networking protocol and includes service discovery, address assignment, and hostname resolution. BONJOUR locates devices such as printers, computers, and services that may be provided by those devices on a LAN using mDNS service records. BONJOUR may run on APPLE's operating systems or other operating systems, including MICROSOFT WINDOWS. BONJOUR may find and notify a service through local multicast. Many devices, servers, and other network services, such as a printer, a network camera (e.g., webcam), web server software (e.g., APACHE), etc., may support BONJOUR. BONJOUR may be applied to various software platforms. However, the service is limited to a layer 2 network and does not cross a layer 3 network. Therefore, the service cannot be found in the whole network, which may be inconvenient for applications in the whole network.

Various examples of the present disclosure provide a method for implementing a BONJOUR service, applied to a network device in a subnet of a network, in which the network may include a plurality of subnets. The network device may serve as a BONJOUR monitoring device within the subnet. The network may also include a BONJOUR manager, which may be any server in the network or a newly-added server in the network. For convenience of description, hereinafter the subnet to which the BONJOUR monitoring device belongs may also refer to as a local subnet.

A network device in any subnet of the network may be a layer-2 switch or a router. A network device in a subnet may be selected as the BONJOUR monitoring device in the subnet to implement functions of the BONJOUR monitoring device. According to an example of the present disclosure, a gateway device may be selected as the BONJOUR monitoring device. According to another example of the present disclosure, a non-gateway device may be selected as the BONJOUR monitoring device. When sending a packet to the BONJOUR manager, the BONJOUR monitoring device, which may be a gateway device or a non-gateway device, may encapsulate the packet to be sent into an internet protocol (IP) packet, in which a destination IP address of the IP packet may be an IP address of the BONJOUR manager. Transmission of the packet may be implemented as follows. If the BONJOUR monitoring device is a gateway device, the BONJOUR monitoring device may directly forward the packet to a destination device outside the local subnet. If the BONJOUR monitoring device is a non-gateway device, the packet may ultimately be forwarded to the destination device outside the local subnet through a gateway device.

In addition, according to various examples of the present disclosure, a network device may join a corresponding BONJOUR multicast group when the network device accesses the network, so that the network device may receive and process a BONJOUR service announcement packet or a BONJOUR service response packet. As such, when a network card of the network device receives a BONJOUR service announcement packet or a BONJOUR service response packet in a subnet where the network device is located, in which the subnet may be referred to as a local subnet, if a destination IP address of the packet belongs to BONJOUR multicast group which the network device joins, the network device may process the packet. Otherwise, the network device may discard the BONJOUR service announcement packet or the BONJOUR service response packet received through the network card. According to various examples of the present disclosure, a network device serving as the BONJOUR monitoring device may join all of the BONJOUR multicast groups in a subnet to which the BONJOUR monitoring device belongs, so that the BONJOUR monitoring device may synchronize BONJOUR services in the subnet with the BONJOUR manager. Synchronizing a service may include storing the same information for the service in each device. The network device serving as the BONJOUR monitoring device may configure an IP address of the BONJOUR manager so as to communicate with the BONJOUR manager.

According to various examples of the present disclosure, the BONJOUR manager may manage BONJOUR services in the whole network. According to an example of the present disclosure, functions of the BONJOUR manager may be deployed on any server in the network, such as a dynamic host configuration protocol (DHCP) server, a domain name system (DNS) server, and etc. According to another example, a new device may be added to deploy the functions of the BONJOUR manager. In this case, the newly-added device may be configured as the BONJOUR manager.

According to various examples of the present disclosure, the BONJOUR monitoring device may monitor BONJOUR services in the subnet to which the BONJOUR monitoring device belongs, i.e., the local subnet. BONJOUR services in the local subnet may be assembled on the BONJOUR manager. When receiving a BONJOUR service in another subnet that is notified by the BONJOUR manager, the BONJOUR monitoring device may send, within the local subnet, a mDNS response packet to announce the received BONJOUR service in the other subnet. When receiving from a local terminal a mDNS packet for querying a BONJOUR service, the BONJOUR monitoring device may respond to the terminal with BONJOUR service in another subnet. By this manner, a terminal in any subnet may find BONJOUR services in the whole network, and BONJOUR services across layer 3 network may be managed through one device.

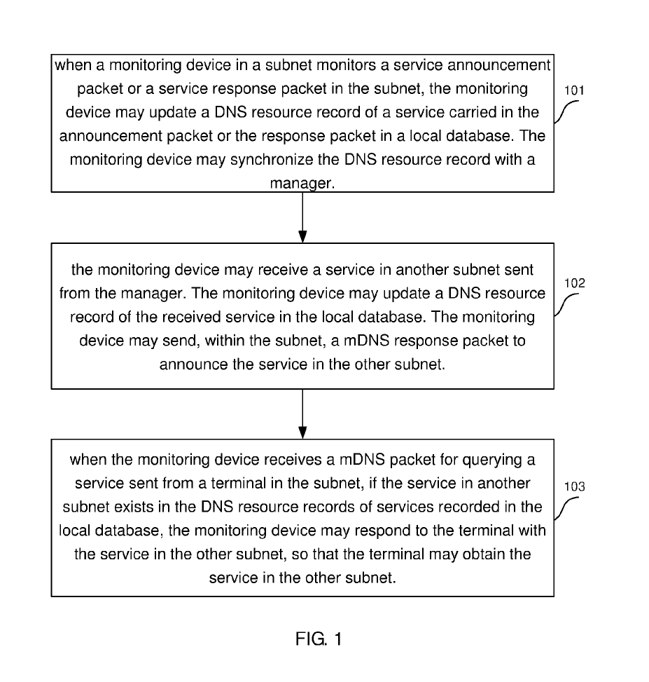

FIG. 1 is a flowchart illustrating a method for implementing a BONJOUR service, according to an example of the present disclosure. The method may be applied to a layer-2 network device in a subnet of a network including a plurality of subnets, wherein the network device serves as the BONJOUR monitoring device in the subnet and the network further includes the BONJOUR manager. As shown in FIG. 1, the method may include the following operations.

In block 101, when the BONJOUR monitoring device in a subnet of the network monitors BONJOUR service announcement packets or BONJOUR service response packets in the subnet, the BONJOUR monitoring device may record or update a DNS resource record of a BONJOUR service carried in the announcement packet or the response packet in a local database of the BONJOUR monitoring device. Also, the BONJOUR monitoring device may synchronize the DNS resource record with the BONJOUR manager in the network. For convenience of description, hereinafter the subnet to which the BONJOUR monitoring device belongs may refer to as a local subnet.

According to another example of the present disclosure, when the BONJOUR monitoring device monitors the BONJOUR service announcement packet or the BONJOUR service response packet in the subnet, the BONJOUR monitoring device may update the DNS resource record of the BONJOUR service carried in the announcement packet or the response packet in the local database. In this case, the updating operation performed by the BONJOUR monitoring device may include various possible operations including:

recording, in the local database, the DNS resource record of the BONJOUR service carried in the announcement packet or the response packet, or

replacing a DNS resource record of the BONJOUR service stored in the local database with the DNS resource record of the BONJOUR service carried in the announcement packet or the response packet, or

deleting the DNS resource record of the BONJOUR service stored in the local database.

According to an example of the present disclosure, contents of the DNS resource record recorded by the BONJOUR monitoring device may include but may not be limited to a service instance name, an IP address, and a service type. In this case, the IP address may be an IP address of a device which responds to or announces BONJOUR service.

According to an example of the present disclosure, when the BONJOUR monitoring device records or updates, in the local database, the DNS resource record of the BONJOUR service carried in the announcement packet or the response packet, the BONJOUR monitoring device may record time to live (TTL) for the DNS resource record. When the TTL recorded for the DNS resource record of BONJOUR service is expired, the BONJOUR monitoring device may initiate a mDNS packet for querying BONJOUR service, so as to determine whether the BONJOUR service still exists.

If the BONJOUR monitoring device receives a packet responding to the mDNS packet for querying the BONJOUR service and a DNS resource record of the BONJOUR service carried in the packet is the same as the DNS resource record recorded by the BONJOUR monitoring device, the BONJOUR monitoring device may refresh the TTL of the DNS resource record recorded by the BONJOUR monitoring device.

If the BONJOUR monitoring device receives the packet responding to the mDNS packet for querying the BONJOUR service and an IP address in the DNS resource record of the BONJOUR service carried in the packet is changed, which may indicate that the BONJOUR service may be provided by another device or an IP address of a device previously providing the BONJOUR service is changed, the BONJOUR monitoring device may record the DNS resource record of the BONJOUR service carried in the packet. According to an example of the present disclosure, multiple devices may respond to the BONJOUR service, i.e., the BONJOUR monitoring device may receive multiple packets responding to the mDNS packet for querying the BONJOUR service. In this case, if IP addresses in DNS resource records, which are carried in the packets responding to the mDNS packet for querying the BONJOUR service, are different from the DNS resource record recorded by the BONJOUR monitoring device, the BONJOUR monitoring device may update the DNS resource record of the BONJOUR service recorded on the local with the DNS resource records of the BONJOUR service carried in all of the packets responding to the mDNS packet for querying BONJOUR service.

If the BONJOUR monitoring device does not receive a packet responding to the mDNS packet for querying the BONJOUR service, the BONJOUR monitoring device may delete the DNS resource record of the queried the BONJOUR service, and notify the BONJOUR manager to delete a DNS resource record of the BONJOUR service associated with the BONJOUR monitoring device and stored in the BONJOUR manager.

As may be seen from the above description that if the mDNS packet for querying the BONJOUR service is not responded, which may indicate that a device previously providing the BONJOUR service may not provide the BONJOUR service currently, the DNS resource record of the BONJOUR service may be deleted. If the mDNS packet for querying the BONJOUR service is responded, it may be determined whether the DNS resource record of the BONJOUR service carried in the response packet is the same as the DNS resource record of the BONJOUR service recorded by the BONJOUR monitoring device, and appropriate processing may be performed according to a determination result. The updated DNS resource record of the BONJOUR service may be synchronized with the BONJOUR manager, so that the BONJOUR manager may update in time and notify the BONJOUR monitoring devices of other subnets. As such, the latest DNS resource records of the BONJOUR services may be recorded within the whole network.

According to an example of the present disclosure, in block 101, the IP address in the DNS resource record of the BONJOUR service carried in the BONJOUR service announcement packet or the BONJOUR service response packet within the local subnet, which is monitored by the BONJOUR monitoring device, may be a local link address or a public network address. If the IP address is the local link address, such as 169.254/16 in IPv4 or FE80::/10 in IPv6, the BONJOUR monitoring device may ignore the DNS resource record of the BONJOUR service and may not record the DNS resource record of the BONJOUR service because the BONJOUR service may not provide the service across subnets.

According to an example of the present disclosure, when the DNS resource record of the BONJOUR service synchronized by the BONJOUR monitoring device to the BONJOUR manager is a newly-added DNS resource record of the BONJOUR service, the BONJOUR monitoring device may query whether a service instance name of the BONJOUR service is recorded on the BONJOUR manager. If the service instance name of the BONJOUR service is recorded on the BONJOUR manager, the BONJOUR monitoring device may configure, based on the service instance name of the BONJOUR service recorded on the BONJOUR manager, a new service instance name for the BONJOUR service in the local subnet. The BONJOUR monitoring device may synchronize the DNS resource record of the BONJOUR service with the BONJOUR manager using the newly-configured service instance name. In addition, the BONJOUR monitoring device may locally map the newly-configured service instance name with the service instance name of the BONJOUR service recorded on the BONJOUR manager.

According to an example of the present disclosure, if a service instance name recorded on the BONJOUR manager is JohnLaptop, a new service instance name may be configured such as JohnLaptop01 or JohnLaptop02. According to another example of the present disclosure, the new service instance name may be named by adding a subnet number or a device name, as a suffix, to the service instance name recorded on the BONJOUR manager. In this case, the BONJOUR monitoring device may maintain a mapping relationship between the service instance name of the BONJOUR service in the local subnet and the service instance name of the BONJOUR service in the global networking for operations such as updating or deleting.

For example, a service instance name of a BONJOUR service in the local subnet is JohnLaptop, while a service instance name of the BONJOUR service in the global networking is JohnLaptop01. The BONJOUR monitoring device of the local subnet may store a mapping relationship between these two service instance names. The BONJOUR monitoring device may use JohnLaptop01 as the service instance name to synchronize the BONJOUR service with the BONJOUR manager. The BONJOUR manager may use JohnLaptop01 as the service instance name to synchronize the BONJOUR service with the BONJOUR monitoring devices in other subnets. When the BONJOUR service in the local subnet is updated, such as changed or deleted, the BONJOUR monitoring device may synchronize with the BONJOUR manager a state of the BONJOUR service based on the mapping relationship between the service instance name of the BONJOUR service in the local subnet and the service instance name of the BONJOUR service in the global networking.

In block 102, the BONJOUR monitoring device may receive a BONJOUR service in another subnet sent from the BONJOUR manager. The BONJOUR monitoring device may record or update a DNS resource record of the received BONJOUR service in the local database. The BONJOUR monitoring device may send, within the local subnet, an mDNS response packet to announce the BONJOUR service in the other subnet associated with the DNS resource record that is recorded by the BONJOUR monitoring device.

According to another example of the present disclosure, when the BONJOUR monitoring device receives the BONJOUR service in the other subnet, the BONJOUR monitoring device may update, in the local database, the DNS resource record of the BONJOUR service in the other subnet. In this case, the updating operation performed by the BONJOUR monitoring device may include various possible operations including:

recording, in the local database, the DNS resource record of the BONJOUR service in the other subnet, or

replacing a DNS resource record of the BONJOUR service in the other subnet stored in the local database with the received DNS resource record of the BONJOUR service in the other subnet, or

deleting the DNS resource record of the BONJOUR service in the other subnet stored in the local database.

If the DNS resource record of the BONJOUR service sent from the BONJOUR manager is received for the first time, the BONJOUR monitoring device may directly record the DNS resource record. If the DNS resource record of the BONJOUR service sent from the BONJOUR manager is recorded by the BONJOUR monitoring device, the BONJOUR monitoring device may update the recorded DNS resource record of the BONJOUR service. In this case, the updating operation performed by the BONJOUR monitoring device may include various possible operations including changing, deleting, and so on.

In block 103, when the BONJOUR monitoring device receives a mDNS packet for querying a the BONJOUR service sent from a terminal in the local subnet, if the BONJOUR service in another subnet exists in the DNS resource records of the BONJOUR services recorded in the local database, the BONJOUR monitoring device may respond to the terminal with the BONJOUR service in the other subnet, so that the terminal may obtain the BONJOUR service in the other subnet.

According to various examples of the present disclosure, when the terminal in the local subnet sends the mDNS packet for querying the BONJOUR service, if there is a device providing the BONJOUR service in the local subnet, the device may respond to the terminal with the BONJOUR service. Meanwhile, the BONJOUR monitoring device may receive the mDNS packet for querying the BONJOUR service. the BONJOUR monitoring device may search DNS resource records of the BONJOUR services in other subnets that are recorded by the BONJOUR monitoring device for a DNS resource record of the queried the BONJOUR service. If the DNS resource record of the queried the BONJOUR service exists in the DNS resource records of the BONJOUR services in other subnets that are recorded by the BONJOUR monitoring device, the BONJOUR monitoring device may respond to the terminal with the BONJOUR service in the other subnet. If the DNS resource record of the queried BONJOUR service does not exist in the DNS resource records of the BONJOUR services in other subnets that are recorded by the BONJOUR monitoring device, the BONJOUR monitoring device may not respond to the terminal.

According to an example of the present disclosure, it may be determined, based on a service type, whether there is the DNS resource record of the BONJOUR service. In this case, if there is a BONJOUR service of which a service type is the same as that of the BONJOUR service queried by the terminal, the BONJOUR service may be responded to the terminal.

According to various examples of the present disclosure, the terminal may receive multiple BONJOUR services which have a same service type. The multiple BONJOUR services may include a BONJOUR service provided by a device in the local subnet and/or a BONJOUR service provided by a device in the other subnet. The terminal may select a BONJOUR service associated with a service instance name according to actual requirements. The terminal may obtain, based on an IP address in the DNS resource record of the selected BONJOUR service, the BONJOUR service from a device that may provide the selected BONJOUR service associated with the service instance name.

The BONJOUR services in the whole network may be centrally managed on the BONJOUR manager. For example, terminals in a subnet may be prohibited from obtaining a BONJOUR service in other subnets. According to another example of the present disclosure, a terminal may be prohibited from obtaining a BONJOUR service in other subnets. When the BONJOUR manager configures a management rule as described above, the BONJOUR manager may notify the management rule to an appropriate BONJOUR monitoring device, so that the BONJOUR monitoring device may respond to multicast query or forward BONJOUR protocol traffic based on the management rule. As such, according to an example of the present disclosure, the BONJOUR monitoring device may receive the management rule notified by the BONJOUR manager and save the rule in the local database. According to an example of the present disclosure, the management rule may be defined to prohibit at least one terminal in the local subnet from obtaining a BONJOUR service in another subnet, for example, a terminal 1 and a terminal 2 in the local subnet may be prohibited from obtaining one or more than one BONJOUR service in another subnet or in other several subnets. In another example, a terminal 3 in the local subnet may be prohibited from obtaining a BONJOUR service in other subnets. According to an example, the BONJOUR service may be a printing service.

When the BONJOUR monitoring device receives a mDNS packet for querying the BONJOUR service prohibited by the management rule which is sent from any of the at least one terminal in the local subnet, the BONJOUR monitoring device may not respond to the terminal with BONJOUR service in the other subnet prohibited by the management rule. For example, when the BONJOUR monitoring device receives a mDNS packet for querying the printing service which is sent from the terminal 3 in the local subnet, the BONJOUR monitoring device may not respond to the terminal 3 with the printing service in the other subnet recorded by the BONJOUR monitoring device.

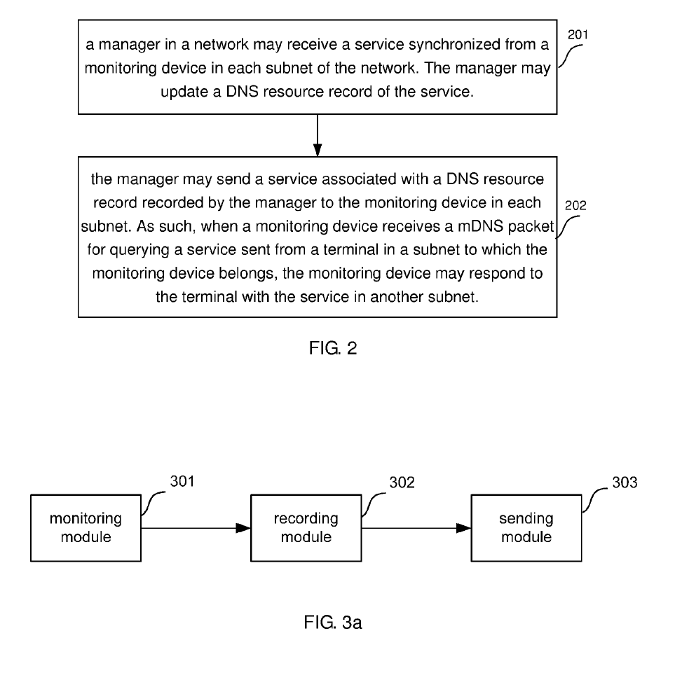

FIG. 2 is a flowchart illustrating a method for implementing a BONJOUR service, according to an example of the present disclosure. As shown in FIG. 2, the method may include the following operations.

In block 201, a BONJOUR manager in a network may receive a BONJOUR service synchronized from a BONJOUR monitoring device in each subnet of the network. The BONJOUR manager may record or update a DNS resource record of BONJOUR service.

According to another example of the present disclosure, when the BONJOUR manager receives the BONJOUR service synchronized from the BONJOUR monitoring device, the BONJOUR manager may locally update the DNS resource record of the BONJOUR service. In this case, the updating operation performed by the BONJOUR manager may include various possible operations including:

recording the DNS resource record of BONJOUR service synchronized from the BONJOUR monitoring device, or

replacing a DNS resource record of BONJOUR service stored by the BONJOUR manager with the DNS resource record of the BONJOUR service synchronized from the BONJOUR monitoring device, or

deleting the DNS resource record of the BONJOUR service stored by the BONJOUR manager.

According to an example of the present disclosure, the BONJOUR manager may receive BONJOUR service synchronized from the BONJOUR monitoring device in each subnet. If the synchronized BONJOUR service is a newly-added BONJOUR service, the BONJOUR manager may record the DNS resource record of the BONJOUR service. If the synchronized BONJOUR service is a BONJOUR service deleted by the BONJOUR monitoring device, the BONJOUR manager may delete the DNS resource record of the BONJOUR service stored by the BONJOUR manager.

In block 202, the BONJOUR manager may send a BONJOUR service associated with a DNS resource record recorded by the BONJOUR manager to the BONJOUR monitoring device in each subnet. As such, when a BONJOUR monitoring device receives a mDNS packet for querying a BONJOUR service that is sent from a terminal in a subnet to which the BONJOUR monitoring device belongs, the BONJOUR monitoring device may respond to the terminal with the BONJOUR service in another subnet.

The BONJOUR manager may send the BONJOUR service associated with the updated DNS resource record to the BONJOUR monitoring device in each subnet, so that the BONJOUR monitoring device in each subnet may update a DNS resource record of the BONJOUR service in the other subnet recorded by the BONJOUR monitoring device.

According to an example of the present disclosure, when a DNS resource record recorded by the BONJOUR manager is updated, the BONJOUR manager may send the BONJOUR service associated with the updated DNS resource record to the BONJOUR monitoring device in each subnet. According to another example of the present disclosure, the BONJOUR manager may periodically send BONJOUR service associated with the updated DNS resource record to the BONJOUR monitoring device in each subnet.

According to an example of the present disclosure, in order to avoid causing a heavy burden on the network, a frequency for transmitting an updating packet by the BONJOUR manager may be restricted, e.g., no more than one packet may be transmitted in every 3 seconds.

According to specific configurations, the BONJOUR manager may send BONJOUR services in the whole network to a BONJOUR monitoring device in a subnet. Alternatively, the BONJOUR manager may send to the BONJOUR monitoring device BONJOUR services in subnets other than the subnet to which the BONJOUR monitoring device belongs.

The BONJOUR manager may configure a management rule for each subnet and send the management rule to the BONJOUR monitoring device in each subnet. As such, the BONJOUR monitoring device in each subnet may determine, based on the management rule, whether to respond to a mDNS packet sent from a terminal in a subnet to which the BONJOUR monitoring device belongs.

The BONJOUR service in the whole network may be centrally managed on the BONJOUR manager, e.g., terminals in a subnet may be prohibited from obtaining a BONJOUR service in another subnet, or a user may be prohibited from obtaining a BONJOUR service.

According to an example of the present disclosure, the management rule configured by the BONJOUR manager may include prohibiting at least one terminal from obtaining a BONJOUR service in a subnet other than a subnet where the terminal locates. For example, a terminal 1 in a subnet 1 may be prohibited from obtaining a BONJOUR service in a subnet other than the subnet 1, such as a BONJOUR Service 1. In another example, a terminal 1 and a terminal 2 in a subnet 2 may be prohibited from obtaining one or more than one BONJOUR service in a subnet other than the subnet 2, such as a BONJOUR Service 3.

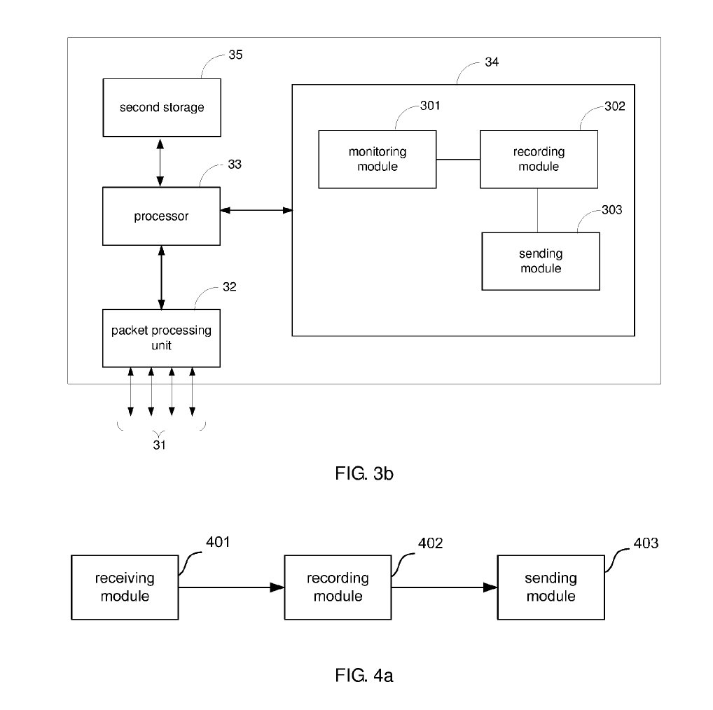

Various examples of the present disclosure may also provide a network device in a network which may include a plurality of subnets. The network may further include a BONJOUR manager, which may be any server in the network or a newly-added server in the network. FIG. 3a is a schematic diagram illustrating a structure of the network device, according to an example of the present disclosure. When the network device serves as a the BONJOUR monitoring device in a subnet to which the network device belongs, the network device may include a monitoring module 301, a recording module 302, and a sending module 303. For convenience of description, hereinafter the subnet to which the BONJOUR monitoring device belongs may also be referred to as a local subnet.

The monitoring module 301 may monitor BONJOUR service announcement packets or BONJOUR service response packets in the local subnet, and receive a BONJOUR service in another subnet sent from the BONJOUR manager. The monitoring module 301 may also receive a mDNS packet for querying a BONJOUR service sent from a terminal within the local subnet.

When a BONJOUR service announcement packet or a BONJOUR service response packet in the local subnet is monitored by the monitoring module 301, the recording module 302 may record or update, in a local database of the BONJOUR monitoring device, a DNS resource record of a BONJOUR service carried in the announcement packet or the response packet. When the monitoring module 301 receives the BONJOUR service in the other subnet sent from the BONJOUR manager, the recording module 302 may record or update, in the local database, a DNS resource record of the BONJOUR service in the other subnet.

The sending module 303 may synchronize the BONJOUR service associated with the DNS resource record recorded by the recording module 302 in the local database with the BONJOUR manager. When the recording module 302 records or updates, in the local database, the DNS resource record of the BONJOUR service in the other subnet, the sending module 303 may send, within the local subnet, a mDNS response packet to announce the BONJOUR service in the other subnet associated with the DNS resource record recorded by the BONJOUR monitoring device. When the monitoring module 301 receives the mDNS packet for querying a BONJOUR service sent from the terminal within the local subnet, if BONJOUR service in another subnet exists in DNS resource records of BONJOUR services recorded in the local database, the sending module 303 may respond to the terminal with the BONJOUR service in the other subnet, so that the terminal may obtain the BONJOUR service in the other subnet.

According to an example of the present disclosure, when the DNS resource record of the BONJOUR service carried in the announcement packet or the response packet is recorded or updated in the local database, the recording module 302 may further record TTL for the DNS resource record. When the monitoring module 301 receives a packet responding to a mDNS packet for querying the BONJOUR service, and a DNS resource record of the BONJOUR service carried in the packet is the same as the DNS resource record of BONJOUR service recorded by the BONJOUR monitoring device, the recording module 302 may refresh the TTL of the DNS resource record that is recorded by the BONJOUR monitoring device. When the monitoring module 301 receives the packet responding to the mDNS packet for querying the BONJOUR service, and an IP address in the DNS resource record of the BONJOUR service carried in the packet is changed, which may indicate that the BONJOUR service may be provided by another device or an IP address of a device previously providing the BONJOUR service is changed, the recording module 302 may record the DNS resource record of the BONJOUR service. If the monitoring module 301 does not receive the packet responding to the mDNS packet for querying the BONJOUR service, the recording module 302 may delete the DNS resource record of the BONJOUR service recorded by the BONJOUR monitoring device, and notify the BONJOUR manager to delete the DNS resource record of the BONJOUR service associated with the BONJOUR monitoring device and recorded by the BONJOUR manager.

In this case, when the TTL recorded by the recording module 302 for the DNS resource record of the BONJOUR service is expired, the sending module 303 may further initiate the mDNS packet for querying the BONJOUR service associated with the DNS resource record. The monitoring module 301 may further receive the packet responding to the mDNS packet for querying the BONJOUR service.

According to an example of the present disclosure, when an IP address in the DNS resource record of the BONJOUR service carried in the BONJOUR service announcement packet or the BONJOUR service response packet within the local subnet that is monitored by the monitoring module 301 is a local link address, the recording module 302 may not record the DNS resource record of the BONJOUR service.

According to an example of the present disclosure, when the DNS resource record of the BONJOUR service synchronized by the BONJOUR monitoring device to the BONJOUR manager is a newly-added DNS resource record of the BONJOUR service, the sending module 303 may query whether a service instance name of the BONJOUR service is recorded on the BONJOUR manager. If the service instance name of the BONJOUR service is recorded on the BONJOUR manager, the sending module 303 may configure a new service instance name in the local subnet based on the service instance name of the BONJOUR service recorded on the BONJOUR manager, and synchronize the DNS resource record of the BONJOUR service with the BONJOUR manager using the newly-configured service instance name. The sending module 303 may map the newly-configured service instance name with the service instance name of the BONJOUR service recorded on the BONJOUR manager, and store a mapping relationship between these two service instance names.

According to an example of the present disclosure, the monitoring module 301 may further receive a management rule notified by the BONJOUR manager. The recording module 302 may further store the management rule monitored by the monitoring module 301 in the local database.

When the management rule stored by the recording module 302 in the local database may be defined to prohibit at least one terminal in the local subnet from obtaining a BONJOUR service in another subnet, and the BONJOUR monitoring device receives a mDNS packet for querying the BONJOUR service prohibited by the management rule which is sent from any of the at least one terminal in the local subnet, the sending module 303 may not respond to the terminal with the BONJOUR service in the other subnet prohibited by the management rule.

The above-mentioned modules in the examples of the present disclosure may be deployed either in a centralized or a distributed configuration, and may be either merged into a single module, or further split into a plurality of sub-modules.

These modules may be software (e.g., machine readable instructions stored in a non-transitory computer readable medium and executable by a processor), hardware (e.g., the processor of an Application Specific Integrated Circuit (ASIC)), or a combination thereof.

FIG. 3b is a schematic diagram illustrating a hardware structure of the network device serving as the BONJOUR monitoring device, according to an example of the present disclosure. As shown in FIG. 3b, the network device may include ports 31, a packet processing unit 32, a processor 33, a first storage 34, and a second storage 35. The packet processing unit 32 may transmit packets including data packets and protocol packets received via the ports 31 to the processor 33 for processing, and may transmit data packets and protocol packets from the processor 33 to the ports 31 for forwarding. The first storage 34 may store machine-readable instructions. The processor 33 may execute the machine-readable instructions to:

upon monitoring a the BONJOUR service announcement packet or a the BONJOUR service response packet in the subnet, update, in the second storage 35, a domain name system (DNS) resource record of a BONJOUR service carried in the BONJOUR service announcement packet or the BONJOUR service response packet, and synchronize the DNS resource record of BONJOUR service with the BONJOUR manager;

receive a BONJOUR service in another subnet sent from the BONJOUR manager; update, in the second storage 35, a DNS resource record of the BONJOUR service in the other subnet; and send, within the subnet, a multicast domain name system (mDNS) response packet to announce the BONJOUR service in the other subnet; and

receive a mDNS packet for querying the BONJOUR service sent from a terminal in the subnet; if the BONJOUR service in the other subnet exists in DNS resource records of BONJOUR services recorded in the second storage, respond to the terminal with the BONJOUR service in the other subnet, so that the terminal obtains the BONJOUR service in the other subnet.

According to an example of the present disclosure, the processor 33 is to execute the machine-readable instructions to:

record time to live (TTL) for the DNS resource record of the BONJOUR service in the second storage 35;

when the TTL is expired, initiate a mDNS packet for querying the BONJOUR service associated with the DNS resource record;

upon receiving a packet responding to the mDNS packet for querying the BONJOUR service and a DNS resource record of the BONJOUR service carried in the packet is the same as the DNS resource record of the BONJOUR service in the second storage 35, refresh the TTL of the DNS resource record of the BONJOUR service in the second storage 35; and

if the packet responding to the mDNS packet for querying the BONJOUR service is not received, delete the DNS resource record of the BONJOUR service in the second storage 35, and notify the BONJOUR manager to delete a DNS resource record of the BONJOUR service associated with the BONJOUR monitoring device and stored in the BONJOUR manager.

According to an example of the present disclosure, the processor 33 is to execute the machine-readable instructions to:

if an internet protocol (IP) address in the DNS resource record of a BONJOUR service carried in the BONJOUR service announcement packet or the BONJOUR service response packet within the subnet is a local link address, not record the DNS resource record of the BONJOUR service.

According to an example of the present disclosure, the processor 33 is to execute the machine-readable instructions to:

query whether a service instance name of a BONJOUR service in the network is recorded on the BONJOUR manager;

if the service instance name of the BONJOUR service in the network is recorded on the BONJOUR manager, configure a new service instance name for the BONJOUR service in the subnet based on the service instance name of the BONJOUR service in the network;

synchronize the DNS resource record of the BONJOUR service with the BONJOUR manager using the new service instance name; and

map the service instance name of the BONJOUR service in the network and the new service instance name of the BONJOUR service in the subnet.

According to an example of the present disclosure, the processor 33 is to execute the machine-readable instructions to:

receive a management rule notified by the BONJOUR manager; wherein the management rule comprises prohibiting at least one terminal in the subnet from obtaining a BONJOUR service in the other subnet;

store the management rule in the second storage 35; and

upon receiving a mDNS packet for querying the BONJOUR service prohibited by the management rule which is sent from any of the at least one terminal in the subnet, not respond to the terminal with the BONJOUR service in the other subnet prohibited by the management rule.

As may be seen from the above description that, when the machine-readable instruction modules stored in the first storage 34 are executed by the processor 33, functions of the aforementioned monitoring module 301, the recording module 302, and the sending module 303 may be achieved.

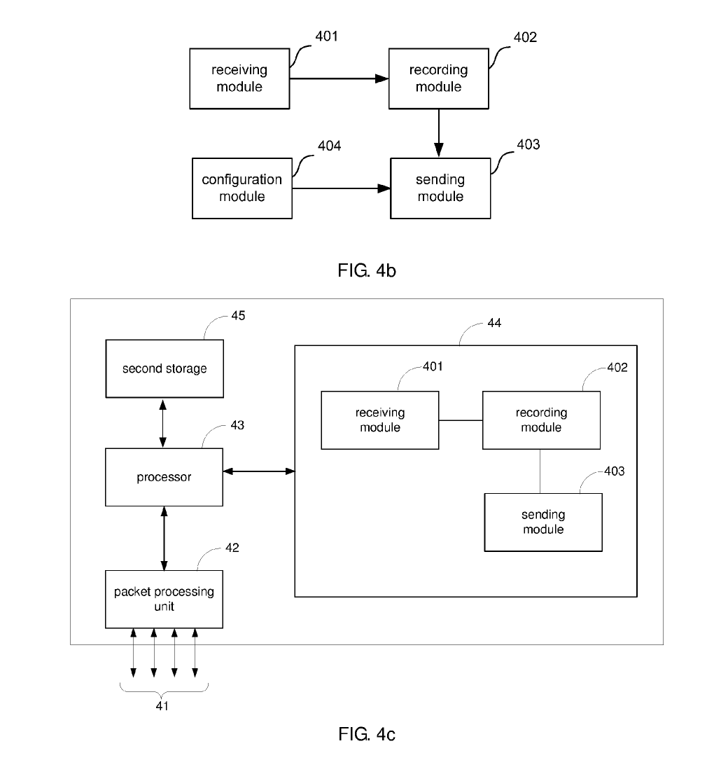

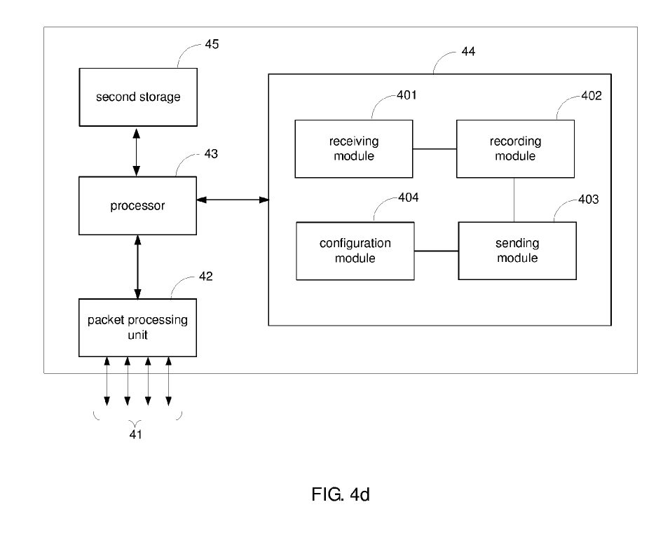

Various examples of the present disclosure may also provide a network device, applied to a network device in a network which may include a plurality of subnets. The network may further include a BONJOUR manager, which may be any server in the network or a newly-added server in the network. Each of a plurality of the subnets may include a network device serving as a BONJOUR monitoring device. FIG. 4a is a schematic diagram illustrating a structure of the network device, according to an example of the present disclosure. When the network device serves as the BONJOUR manager, the network device may include a receiving module 401, a recording module 402, and a sending module 403. For convenience of description, hereinafter a subnet to which a the BONJOUR monitoring device belongs may be referred to as a local subnet.

The receiving module 401 may receive a BONJOUR service synchronized from a BONJOUR monitoring device in each subnet.

When the receiving module 401 receives the BONJOUR service synchronized from the BONJOUR monitoring device in each subnet, the recording module 402 may record or update a DNS resource record of the BONJOUR service.

According to another example of the present disclosure, when the receiving module 401 receives the BONJOUR service synchronized from the BONJOUR monitoring device in each subnet, the recording module 402 may update the DNS resource record of the BONJOUR service. In this case, the updating operation performed by the recording module 402 may include various possible operations including:

recording the DNS resource record of the BONJOUR service synchronized from the BONJOUR monitoring device, or

replacing a DNS resource record of the BONJOUR service stored by the BONJOUR manager with the DNS resource record of the BONJOUR service synchronized from the BONJOUR monitoring device, or

deleting the DNS resource record of the BONJOUR service stored by the BONJOUR manager.

The sending module 403 may send, to the BONJOUR monitoring device in each subnet, BONJOUR services associated with all of DNS resource records recorded by the recording module 402, so that when the BONJOUR monitoring device receives a mDNS packet for querying a BONJOUR service that is sent from a terminal in a subnet to which the BONJOUR monitoring device belongs, the BONJOUR monitoring device may respond to the terminal with the BONJOUR service in another subnet.

According to an example of the present disclosure, when the BONJOUR service synchronized from the BONJOUR monitoring device in each subnet and received by the receiving module 401 is a newly-added BONJOUR service, the recording module 402 may record the DNS resource record of the BONJOUR service. When the BONJOUR service synchronized from the BONJOUR monitoring device in each subnet and received by the receiving module 401 is a BONJOUR service deleted by the BONJOUR monitoring device, the recording module 402 may delete the DNS resource record of the BONJOUR service recorded by the BONJOUR manager.

The sending module 403 may send the BONJOUR service associated with the updated DNS resource record to the BONJOUR monitoring device in each subnet, so that the BONJOUR monitoring device in each subnet may update a DNS resource record of the BONJOUR service in the other subnet recorded by the BONJOUR monitoring device.

According to an example of the present disclosure, as shown in FIG. 4b, the network device serving as the BONJOUR manager may further include a configuration module 404. The configuration module 404 may configure a management rule for each subnet. According to an example of the present disclosure, the management rule may include prohibiting at least one terminal from obtaining a BONJOUR service in a subnet other than a subnet where the terminal locates.

The sending module 403 may send the management rule to the BONJOUR monitoring device in each subnet. As such, the BONJOUR monitoring device in each subnet may determine, based on the management rule, whether to respond to a mDNS packet sent from a terminal in a subnet to which the BONJOUR monitoring device belongs.

The above-mentioned modules in the examples of the present disclosure may be deployed either in a centralized or a distributed configuration, and may be either merged into a single module, or further split into a plurality of sub-modules.

These modules may be software (e.g., machine readable instructions stored in a non-transitory computer readable medium and executable by a processor), hardware (e.g., the processor of an ASIC), or a combination thereof.

FIG. 4c is a schematic diagram illustrating a hardware structure of the network device serving as the BONJOUR manager, according to an example of the present disclosure. As shown in FIG. 4c, the network device may include ports 41, a packet processing unit 42, a processor 43, a first storage 44, and a second storage 45. The packet processing unit 42 may transmit packets including data packets and protocol packets received via the ports 41 to the processor 43 for processing, and may transmit data packets and protocol packets from the processor 43 to the ports 41 for forwarding. The first storage 44 may store machine-readable instructions. The processor 43 may execute the machine-readable instructions to:

receive a BONJOUR service synchronized from a the BONJOUR monitoring device in a subnet;

update, in the second storage 45, a domain name system (DNS) resource record of the BONJOUR service synchronized from the BONJOUR monitoring device; and

send BONJOUR services associated with all of DNS resource records recorded by the BONJOUR manager in the second storage 45 to the BONJOUR monitoring device, so that when the BONJOUR monitoring device receives a mDNS packet for querying a BONJOUR service sent from a terminal in the subnet, the BONJOUR monitoring device responds to the terminal with the BONJOUR service in another subnet.

According to an example of the present disclosure, the processor 43 is to execute the machine-readable instructions to:

when the BONJOUR service synchronized from the BONJOUR monitoring device is a newly-added BONJOUR service, record the DNS resource record of BONJOUR service in the second storage 45; and

when the BONJOUR service synchronized from the BONJOUR monitoring device is a BONJOUR service deleted by the BONJOUR monitoring device, delete a DNS resource record of the BONJOUR service recorded in the second storage 45 by the BONJOUR manager;

According to an example of the present disclosure, the processor 43 is to execute the machine-readable instructions to:

send the BONJOUR service associated with the updated DNS resource record to the BONJOUR monitoring device, so that the BONJOUR monitoring device updates a DNS resource record of BONJOUR service in the other subnet recorded by the BONJOUR monitoring device.

According to an example of the present disclosure, the processor 43 is to execute the machine-readable instructions to:

configure a management rule for each of a plurality of the subnets; and

send the management rule to the BONJOUR monitoring device in each of a plurality of the subnets, so that the BONJOUR monitoring device determines, based on the management rule, whether to respond to a mDNS packet sent from a terminal in a subnet to which the BONJOUR monitoring device belongs;

wherein the management rule comprises prohibiting at least one terminal from obtaining a BONJOUR service in a subnet other than a subnet where the at least one terminal locates.

As may be seen from the above description that, when the machine-readable instruction modules stored in the first storage 44 are executed by the processor 43, functions of the aforementioned receiving module 401, the recording module 402, the sending module 403, and the configuration module 404 may be achieved. Therefore, an example of the hardware structure of the network device serving as the BONJOUR manager is shown in FIG. 4d.

As may be seen from the above description that according to various examples of the present disclosure, a the BONJOUR monitoring device in a subnet may monitor BONJOUR services in the subnet. BONJOUR services in the subnet may be assembled on a BONJOUR manager. The BONJOUR monitoring device may receive and record a BONJOUR service in another subnet that is notified by the BONJOUR manager. When receiving from a local terminal a mDNS packet for querying a BONJOUR service, the BONJOUR monitoring device may respond to the terminal with a corresponding BONJOUR service in another subnet. By this manner, a terminal in any subnet may find BONJOUR services in the whole network, and BONJOUR services across layer 3 network may be managed through one device.

The above examples may be implemented by hardware, software or firmware, or a combination thereof. For example, the various methods, processes and functional modules described herein may be implemented by a processor (the term processor is to be interpreted broadly to include a CPU, processing unit, ASIC, logic unit, programmable gate array, etc.). The processes, methods, and functional modules disclosed herein may all be performed by a single processor or split between several processors. In addition, reference in this disclosure or the claims to a ‘processor’ should thus be interpreted to mean ‘one or more processors’. The processes, methods and functional modules disclosed herein may be implemented as machine readable instructions executable by one or more processors, hardware logic circuitry of the one or more processors or a combination thereof. Further the examples disclosed herein may be implemented in the form of a computer software product. The computer software product may be stored in a non-transitory storage medium and may include a plurality of instructions for making a computer apparatus (which may be a personal computer, a server or a network apparatus such as a router, switch, access point, etc.) implement the methods recited in the examples of the present disclosure.

All or part of the procedures of the methods of the above examples may be implemented by hardware modules following machine readable instructions. The machine readable instructions may be stored in a computer readable storage medium. When running, the machine readable instructions may provide the procedures of the method examples. The storage medium may be diskette, CD, ROM (Read-Only Memory) or RAM (Random Access Memory), and etc.

The figures are illustrations of examples, in which the modules or procedures shown in the figures may not be necessarily essential for implementing the present disclosure. The modules in the aforesaid examples may be combined into one module or further divided into a plurality of sub-modules.

The above are several examples of the present disclosure, and are not used for limiting the protection scope of the present disclosure. Any modifications, equivalents, improvements, etc., made under the principle of the present disclosure should be included in the protection scope of the present disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims and their equivalents in which all terms are meant in their broadest reasonable sense unless otherwise indicated.

1. A method applicable to a network device serving as a monitoring device for a zero-configuration network protocol in a subnet of a network comprising a plurality of subnets, the method comprising:
receiving a service announcement packet or a service response packet in the subnet; updating, in a local database by the monitoring device, a domain name system (DNS) resource record of a service carried in the service announcement packet or the service response packet; and synchronizing the DNS resource record of the service with another network device serving as a manager in the network;
receiving, by the monitoring device, a service in another subnet in the network sent from the manager; updating, in the local database, a DNS resource record of the service in the another subnet; and sending, within the subnet, a multicast domain name system (mDNS) response packet to announce the service in the another subnet; and
receiving, by the monitoring device, a mDNS packet for querying a service, wherein the mDNS packet is sent from a terminal in the subnet; when the queried service is in the another subnet and exists in DNS resource records of services recorded in the local database, responding to the terminal with the queried service in the another subnet, so that the terminal obtains the queried service in the another subnet.

2. The method of claim 1, wherein updating, in the local database by the monitoring device, the DNS resource record of the service carried in the service announcement packet or the service response packet comprises:
recording, by the monitoring device, a time to live (TTL) for the DNS resource record of BONJOUR service in the local database;
when the TTL is expired, initiating, by the monitoring device, a mDNS packet for querying the service associated with the DNS resource record;
when receiving a packet responding to the mDNS packet for querying the service and a DNS resource record of the service carried in the packet is the same as the DNS resource record of the service in the local database, refreshing, by the monitoring device, the TTL of the DNS resource record of the service in the local database; and
when the packet responding to the mDNS packet for querying the service is not received, deleting, by the monitoring device, the DNS resource record of the service in the local database, and notifying the manager to delete a DNS resource record of the service associated with the monitoring device and stored in the manager.

3. The method of claim 1, further comprising:
when an internet protocol (IP) address in the DNS resource record of the service carried in the service announcement packet or the service response packet within the subnet is a local link address, the monitoring device does not record the DNS resource record of the service.

4. The method of claim 1, wherein the DNS resource record of the service synchronized by the monitoring device with the manager is a newly-added DNS resource record of the service, the method further comprising:
querying, by the monitoring device, whether a service instance name of the service is recorded on the manager;
when the service instance name of the service is recorded on the manager, configuring, by the monitoring device, a new service instance name for the service in the subnet based on the service instance name of the service in the network;
synchronizing, by the monitoring device, the DNS resource record of the service with the manager using the new service instance name; and
mapping, by the monitoring device, the service instance name of service in the network and the new service instance name of service in the subnet.

5. The method of claim 1, further comprising:
receiving, by the monitoring device, a management rule notified by the manager; wherein the management rule comprises prohibiting at least one terminal in the subnet from obtaining a particular service in the another subnet;
storing, by the monitoring device, the management rule in the local database; and
when the monitoring device receiving a mDNS packet for querying the particular service prohibited by the management rule which is sent from at least one terminal in the subnet, the monitoring device does not respond to the at least one terminal with the particular service in the another subnet prohibited by the management rule.

6-8. (canceled)

9. A network device in a subnet of a network comprising a plurality of subnets, wherein the network device serves as a monitoring device for a zero-configuration network protocol in the subnet, the network device comprising:
a first storage, to store machine-readable instructions; and
a processor, to execute the machine-readable instructions to:
receive a service announcement packet or a service response packet in the subnet, update, in a second storage, a domain name system (DNS) resource record of a service carried in the service announcement packet or the service response packet, and synchronize the DNS resource record of the service with another network device serving as a manager in the network;
receive service in another subnet of the network sent from the manager; update, in the second storage, a DNS resource record of the service in the another subnet; and send, within the subnet, a multicast domain name system (mDNS) response packet to announce the service in the another subnet; and
receive a mDNS packet for querying a service sent from a terminal in the subnet; when the queried service is in the another subnet and exists in DNS resource records of services recorded in the second storage, respond to the terminal with the queried service in the another subnet, so that the terminal obtains the queried service in the another subnet.

10. The network device of claim 9, wherein the processor is to execute the machine-readable instructions to:
record a time to live (TTL) for the DNS resource record of the service in the second storage;
when the TTL is expired, initiate a mDNS packet for querying the service associated with the DNS resource record;
when receiving a packet responding to the mDNS packet for querying the service and a DNS resource record of service carried in the packet is the same as the DNS resource record of the service in the second storage, refresh the TTL of the DNS resource record of service in the second storage; and
when the packet responding to the mDNS packet for querying the service is not received, delete the DNS resource record of the service in the second storage, and notify the manager to delete a DNS resource record of the service associated with the monitoring device and stored in the manager.

11. The network device of claim 9, wherein the processor is to execute the machine-readable instructions to:
when an internet protocol (IP) address in the DNS resource record of service carried in the service announcement packet or the service response packet within the subnet is a local link address, not record the DNS resource record of the service.

12. The network device of claim 9, wherein the processor is to execute the machine-readable instructions to:
query whether a service instance name of the service is recorded on the manager;
when the service instance name of the service in the network is recorded on the manager, configure a new service instance name for the service in the subnet based on the service instance name of the service in the network;
synchronize the DNS resource record of the service with the manager using the new service instance name; and
map the service instance name of the service in the network and the new service instance name of the service in the subnet.

13. The network device of claim 9, wherein the processor is to execute the machine-readable instructions to:
receive a management rule notified by the manager; wherein the management rule comprises prohibiting at least one terminal in the subnet from obtaining a particular service in the another subnet;
store the management rule in the second storage; and
when receiving a mDNS packet for querying the particular service prohibited by the management rule which is sent from at least one terminal in the subnet, not respond to the terminal with the particular service in the another subnet prohibited by the management rule.

14. A network device, applied to a network comprising a plurality of subnets, wherein said network device serves as a manager for a zero-configuration network protocol, the network device comprising:
a first storage, to store machine-readable instructions; and
a processor, to execute the machine-readable instructions to:
receive service information for synchronizing a service from a network device serving as a monitoring device in a subnet in the network;
update, in a second storage, a domain name system (DNS) resource record of the service; and
send services associated with DNS resource records recorded by the manager to the monitoring device, wherein the services include at least one service in another subnet of the network, and when the monitoring device receives a mDNS packet for querying the at least one service from a terminal in the subnet, the monitoring device responds to the terminal with the at least one service in the another subnet.

15. The network device of claim 14, wherein the processor is to execute the machine-readable instructions to:
when the service is a newly-added service, record the DNS resource record of service; and
when service is a service deleted by the monitoring device, delete a DNS resource record of service recorded by the manager;
the processor is to execute the machine-readable instructions to:
send the service associated with the updated DNS resource record to the monitoring device, so that the monitoring device updates a DNS resource record of the service in the another subnet recorded by the monitoring device.

16. The network device of claim 14, wherein the processor is to execute the machine-readable instructions to:
configure a management rule for each of the plurality of the subnets; and
send the management rule to a monitoring device in each subnet, so that each monitoring device determines, based on the management rule, whether to respond to a mDNS packet sent from a terminal in its subnet;
wherein the management rule comprises prohibiting at least one terminal from obtaining a service in a subnet other than a subnet where the at least one terminal is located.
